(19) United States
(12) Patent Application Publication
(10) Pub. No.: US 2014/0064750 A1
(43) Pub. Date: Mar. 6, 2014

(54) DEVELOPER AND TEST METHOD THEREOF

(71) Applicant: Toshiba Tec Kabushiki Kaisha, Tokyo (JP)

(72) Inventors: Takafumi HARA, Shizuoka-ken (JP); Masahiro IKUTA, Shizuoka-ken (JP); Tsuyoshi ITOU, Shizuoka-ken (JP); Motonari UDO, Shizuoka-ken (JP); Kazuhisa TAKEDA, Shizuoka-ken (JP); Takayasu AOKI, Shizuoka-ken (JP)

(21) Appl. No.: 13/936,751

(22) Filed: Jul. 8, 2013

(30) Foreign Application Priority Data
Sep. 4, 2012 (JP) 2012-194371

(51) Int. Cl. B41M 5/30; G01N 25/00

(52) U.S. Cl. CPC B41M 5/305; G01N 25/00
USPC 399/28; 503/200; 503/226; 503/201

(57) ABSTRACT

A color-fadable developer contains a binder resin, a color generation compound and a color developing agent. When the developer is heated from a temperature range of 0° C. to 20° C. to a temperature range of 150° C. to 180° C. at a temperature increase rate range of 5° C./min to 10° C./min a first time and a second time, a first differential scanning calorimetry curve based on a measurement by differential scanning calorimetry during the first heating has an endothermic peak that is missing from a second differential scanning calorimetry curve based on a measurement differential scanning calorimetry during the second heating, and has a different peak than the endothermic peak caused by a glass transition point of a binder resin.

### CROSS-REFERENCE TO RELATED APPLICATION

This application is based upon and claims the benefit of priority from Japanese Patent Application No. 2012-194371, filed Sep. 4, 2012, the entire contents of which are incorporated herein by reference.

### FIELD

Embodiments described herein relate to a developer and a method of testing the developer.

### BACKGROUND

In the light of the environmental friendliness and economy achieved by lowering the use of recording mediums such as paper, a method of reusing a recording medium (e.g. paper) by fading the color of the toner image formed on the recording medium to the point where it is invisible or nearly invisible to the human eye, i.e., “erased” is highly effective.

It is well-known that color-fadable toners contain, for example, a color generation compound and a color developing agent and can be faded or a resulting image therefrom erased after being heated. In this method, the color generation compound and the color developing agent are fused and kneaded with a binder resin using a kneading and crushing method and then contained in a toner. As to the toner, the printed part of a sheet can be heated for 1-3 hours at 100-200 degrees to be faded, thus making the treated paper reusable. A toner that can be faded in this manner is an excellent technology contributing to reducing environment pollution by lowering paper consumption.

However, as much time is consumed to fade an image according to this technology, it is desired to fade or erase an image in a shorter time.

### BRIEF DESCRIPTION OF THE DRAWINGS

FIG. 1 illustrates the flow of a test method for the developer involved in one embodiment;

FIG. 2 is a graph illustrating a DSC curve resulting from a first DSC measurement on the developer involved in one embodiment;

FIG. 3 is a graph illustrating a DSC curve resulting from a second DSC measurement on the developer involved in one embodiment;

FIG. 4 is a graph illustrating a DSC curve resulting from a first DSC measurement on a comparative developer;

FIG. 5 is a graph illustrating a DSC curve resulting from a second DSC measurement on a comparative developer.

### DETAILED DESCRIPTION

In accordance with one embodiment, a color-fadable developer contains a binder resin, a color generation compound and a color developing agent. When differential scanning calorimetry is carried out during heating of the color-fadable developer from a temperature range of 0° C. to 20° C. to a temperature of 150° C. to 180° C., at a temperature increase rate range of 5° C./min to 10° C./min, and is then repeated under the same conditions, a first DSC curve based on the first measurement by differential scanning calorimetry has an additional endothermal peak, which is a different endothermic peaks than the endothermic peak caused by the glass transition point of the binder resin in the second DSC curve based on the second measurement by differential scanning calorimetry.

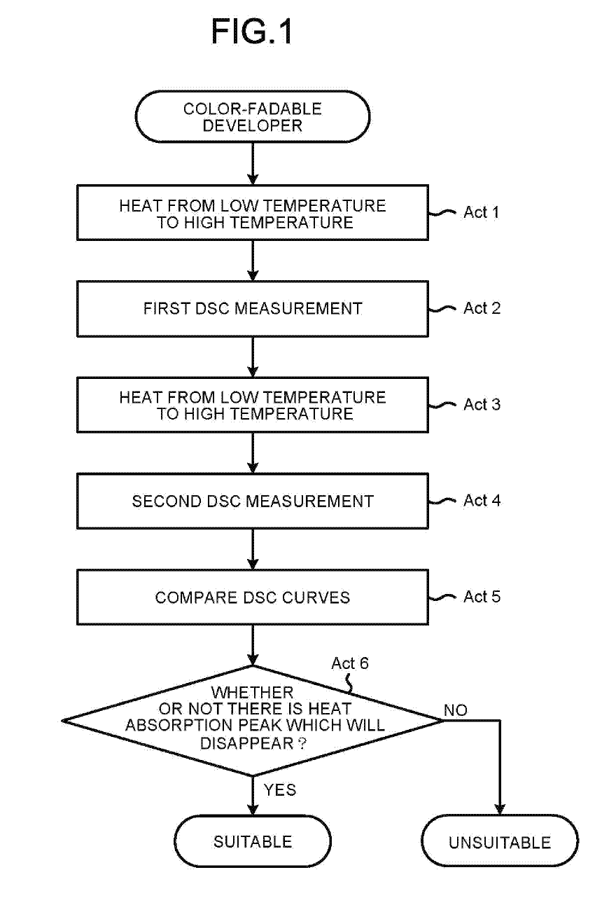

FIG. 1 illustrates a flowchart of the steps of a test method for the developer involved in one embodiment.

In the test method for the developer involved in one embodiment, a color-fadable developer containing a binder resin, a color generation compound and a color developing agent is prepared. Then, the developer is heated from a starting temperature of 0-20 degrees centigrade to 150-180 degrees centigrade at a temperature increase rate of 5-10 degrees/min (ACT 1). Next, differential scanning calorimetry is carried out for the first time (ACT 2). The temperature is increased from a low temperature to a high temperature again (ACT 3). Next, differential scanning calorimetry is carried out for a second time (ACT 4). The two DSC curves resulting from the calorimetry are compared (ACT 5) to confirm whether or not the first DSC curve resulting from the first measurement has an endothermic peak which is missing in the second DSC curve obtained from the second measurement and the peak missing in the second curve is different from the endothermic peak caused by the glass transition point of the binder resin. The result of the determination is ‘suitable’ if the first DSC curve has an endothermic peak that is not in the second DSC curve and is a different peak than the endothermic peak caused by the glass transition point of the binder resin, the result of the determination is ‘unsuitable’ if the first DSC curve does not have an endothermic peak that is missing in the second DSC curve and is the missing peak is a different peak than the endothermic peak caused by the glass transition point of the binder resin.

A developer, which can be quickly faded, i.e., within one second, by heating of the color-fadable developer is one where the first DSC curve has the endothermic peak that is missing in the second DSC curve and the missing peak is different than the endothermic peak caused by the glass transition point of the binder resin.

If the initial developer temperature is lower than 0 degrees centigrade in the differential scanning calorimetry analysis, then the peak of the crystallization of the raw material of the toner cannot be detected, and consequentially, the endothermic peak cannot be detected or measured. Further, as the high temperature in the differential scanning calorimetry depends upon the glass transition temperature of the binder resin and the color fading temperature of a coloring agent, if the high temperature used in the differential scanning calorimetry is lower than a full color fading temperature, then the developer cannot be faded completely, and the endothermic peak will not disappear in the second heating and evaluation step.

In the initial heating of the developer, there are a plurality of endothermic peaks in the resulting first DSC curve, and preferably the endothermic peak existing at the highest temperature is the endothermic peak missing in the second DSC curve measured during the second heating of the developer.

If the highest temperature endothermic peak is the endothermic peak which will disappear in the second curve, the colored toner fading will occur at a temperature higher than the fixing temperature of the toner and can thus be fixed in a coloring state. That is, if the highest temperature endothermic peak is not the endothermic peak which will disappear in the second, or re-heating, step, the colored toner fades at a temperature lower than the fixing temperature in the fixer, thereby fading the color of the color-fixed toner with the heat of the fixer.

The color generation compound and the color developing agent may be encapsulated in a microcapsule.

A color fading agent may be contained in the microcapsule as well.

If a color fading agent is contained in the microcapsule, then it is easy to control the reaction, that is, the coloring and fading, of the color generation compound and the color developing agent.

The microcapsule may have a capsule size dispersion of 0.5-7 um,

If the size dispersion is smaller than 0.5 μm, then it is difficult to absorb a color material in the toner, and if the size dispersion is greater than 7 um, then there will be a trend that it is difficult to create practical toner particles.

The color generation compound that can be used in one embodiment is an electron-releasing compound that can develop a color with the use of a color developing agent. Generally, the color generation compound may be leuco dye, which may be, for example, diphenylmethanephthalides, phenylindolylphthalides, indolylphthalides, diphenylmethaneazaphthalides, phenylindolylazaphthalides, fluorans, styryl quinolines and diazarhodaminelactones.

Specifically, the leuco dye is

3,3-Bis(p-dimethylaminophenyl)-6-dimethylaminophthalide,

3-(4-diethylaminophenyl)-3-(1-ethyl-2-methylindole-3-yl)phthalide,

3,3-Bis(1-n-butyl-2-methylindole-3-yl)phthalide,

3,3-Bis(2-ethoxy-4-diethylaminophenyl)-4-azaphthalide,

3-(2-ethoxy-4-diethylaminophenyl)-3-(1-ethyl-2-methylindole-3-yl)-4-azaphthalide,

3-[2-ethoxy-4-(N-ethylanilino)phenyl]-3-(1-ethyl-2-methylindole-3-yl)-4-azaphthalide,

3,6-diphenylaminofluoran,

3,6-dimethoxyfluoran,

3,6-n-dibutoxyfluoran,

2-methyl-6-(N-ethyl-N-p-tolylamino)fluoran.

2-N,N-dibenzylamino-6-diethylaminofluoran,

3-chloro-6-cyclohexylaminofluoran,

2-methyl-6-cyclohexylaminofluoran,

2-(2-chloroanilino)-6-n-dibutylaminofluoran,

2-(3-trifluoromethylanilino)-6-diethylaminofluoran,

2-(N-methylanilino)-6-(N-ethyl-N-p-tolylamino)fluoran,

1,3-dimethyl-6-diethylaminofluoran,

2-chloro-3-methyl-6-diethylaminofluoran,

2-anilino-3-methyl-6-diethylaminofluoran,

2-anilino-3-methyl-6-n-didibutylaminofluoran,

2-xylidine-3-methyl-6-diethylaminofluoran,

1,2-benz-6-diethylaminofluoran,

1,2-benz-6-(N-ethyl-N-isobutylamino)fluoran,

1,2-benz-6-(N-ethyl-N-isoamylamino)fluoran,

2-(3-methoxy-4-dodecoxystyryl)quinoline,

Spiro[5H-(1)benzopyrone(2,3-d)pyrimidine-5,1′(3′H)isobenzofuran]-3′-one,2-(diethylamino)-8-(diethylamino)-4-methyl

Spiro[5H-(1)benzopyrone(2,3-d)pyrimidine-5,1′(3′H)isobenzofuran]-3′-one,2-(di-n-buthylamino)-8-(N-ethyl-N-i-amylam ino)-4-methyl,

Spiro[5H-(1)benzopyrone(2,3-d)pyrimidine-5,1′(3′H)isobenzofuran]-3′-one,2-(n-dibuthylamino)-8-(diethylamino)-4-methyl,

Spiro [5H-(1)benzopyrano(2,3-d)pyrimidine-5,1′(3H)isobenzofuran]-3′-one,2-(n-dibuthylamino)-8-(N-ethyl-N-i-amylamino)-4-methyl,

Spiro [5H-(1)benzopyrano(2,3-d)pyrimidine-5,1′(3H)isobenzofuran]-3′-one,2-(n-dibuthylamino)-8-(n-dibuthylamino)-4-phenyl,

3-(2-metoxy-4-dimethylaminophenyl)-3-(1-butyl-2-methylindole-3-yl)-4,5,6,7-tetrachlorophthalide,

3-(2-ethoxy-4-diethylaminophenyl)-3-(1-ethyl-2-methylindole-3-yl)-4,5,6,7-tetrachlorophthalide and

3-(2-ethoxy-4-diethylaminophenyl)-3-(1-pentyl-2-methylindole-3-yl)-4,5,6,7-tetrachlorophthalide.

In addition, the color generation compound may further be pyridine, quinazoline and bisquinazoline compounds, two or more of which may be used together.

The color developing agent that can be used in the one embodiment is an electron acceptability compound which endows the leuco dye with protons, in other words, it is a proton donor and the color developing agent accepts electrons from the leuco dye. For example, the color developing agent may be phenols, metal salts of phenol, metal salts of carvone acid, aromatic carboxylic acid and aliphatic acids having 2-5 carbons, benzophenones, sulfone acid, sulphonate, phosphoric acids, metal salts of phosphoric acid, alkyl acid phosphate, metal salts of acid phosphate, phosphorous acids, metal salts of phosphorous acid, monophenols, polyphenols, 1,2,3-triazole and derivatives thereof, or may be a component having an alkyl group, an aryl group, an acyl group, an alkoxycarbonyl, a carboxyl group and esters thereof or an amide group, a halogen group serving as a replacing group or the like, and bis- or tris-phenol, phenolaldehyde, condensation resin and metal salts thereof. Two or more of the components above may be used together.

Specifically, the color developing agent may be

phenol,

o-cresol,

tertiary-butylcatechol,

nonylphenol,

n-octylphenol,

n-dodecylphenol,

n-stearylphenol,

p-chlorophenol,

p-bromophenol,

o-phenylphenol,

p-hydroxybenzoic acid n-butyl,

p-hydroxybenzoic acid n-octyl,

p-hydroxybenzoic acid benzyl,

dihydroxybenzoic acid or esters thereof, such as

2,3-dihydroxybenzoic acid,

3,5-dihydroxybenzoic acid,

Resorcinol,

gallic acid,

dodecyl gallate,

ethyl gallate,

butyl gallate,

propyl gallate,

2,2-Bis(4-hydroxyphenyl)propane,

4,4-dihydroxydiphenylsulfone,

1,1-Bis(4-hydroxyphenyl)ethane,

2,2-Bis(4-hydroxy-3-methyl phenyl)propane,

Bis(4-hydroxyphenyl)sulfide,

1-phenyl-1,1′-Bis(4-hydroxyphenyl)ethane,

1,1-Bis(4-hydroxyphenyl)-3-methylbutane,

1,1-Bis(4-hydroxyphenyl)-2-methyl propane,

1,1-Bis(4-hydroxyphenyl)-n-hexane,

1,1-Bis(4-hydroxyphenyl)-n-heptane,

1,1-Bis(4-hydroxyphenyl)-n-octane,

1,1-Bis(4-hydroxyphenyl)-n-nonane,

1,1-Bis(4-hydroxyphenyl)-n-decane,

1,1-Bis(4-hydroxyphenyl)-n-dodecane,

2,2-Bis(4-hydroxyphenyl)butane,

2,2-Bis(4-hydroxyphenyl)ethylpropionate,

2,2-Bis(4-hydroxyphenyl)-4-methylpentane,

2,2-Bis(4-hydroxyphenyl)hexafluoropropane,

2,2-Bis(4-hydroxyphenyl)-n-heptane,

2,2-Bis(4-hydroxyphenyl)-n-nonane,

2,4-dihydroxyacetophenone,

2,5-dihydroxyacetophenone,

2,6-dihydroxyacetophenone,

3,5-dihydroxyacetophenone,

2,3,4-trihydroxyacetophenone,

2,4-dihydroxybenzophenone,

4,4′-dihydroxybenzophenone,

2,3,4-trihydroxybenzophenone,

2,4,4′-trihydroxybenzophenone,

2,2′,4,4′-tetrahydroxybenzophenone

2,3,4,4′-tetrahydroxybenzophenone,

2,4′-biphenol,

4,4′-biphenol,

4-[(4-hydroxyphenyl)methyl]-1,2,3-benzenetriol,

4-[(3,5-dimethyl-4-hydroxyphenyl)methyl]-1,2,3-benzenetriol, 4,6-Bis[(3,5-dimethyl-4-hydroxyphenyl)methyl]-1,2,3-benzenetriol,

4,4′-[1,4-phenylenebis(1-methylethylidene)Bis(benzene-1,2,3-triol)],

4,4′-[1,4-phenylenebis(1-methylethylidene)Bis(1,2-benzenediols)],

4,4′,4″-ethylidenetrisphenol,

4,4′-(1-methylethylidene)bis phenol,

Methylenetris-p-cresol and the like.

The binder resin is preferably polyester resin, for example, the acid component may be dicarboxylic acid, such as terephthalic acid, phthalic acid, isophthalic acid and the like; and carboxylic acid, such as fumaric acid, maleic acid, succinic acid, adipic acid, sebacic acid, glutaric acid, pimelic acid, oxalic acid, malonic acid, citraconic acid and itaconic acid and the like. The alcohol component contained in the polyester resin may be an aliphatic diol such as ethylene glycol, propylene glycol, 1,4-butanediol, 1,3-butanediol, 1,5-pentanediol, 1,6-hexanediol, neopentyl glycol, trimethylene glycol, trimethylolpropane and pentaerythritol, an alicyclic diol such as 1,4-cyclohexanediol and 1,4-cyclohexanedimethyl, the ethylene oxide of bisphenol A or a propylene oxide additive.

Further, the polyester may be constructed as a cross-bridging structure by using polyvalent carboxylic acid having a valence of greater than 3 or an alcohol component having a valence of greater than 3 such as 1,2,4-benzenetricarboxylic acid (trimellitic acid) or glycerin.

Further, the mixture of more than two kinds of polyester resins consisted of different components may be used as the binder resin.

The polyester resin may be non-crystalline polyester resin or crystalline polyester resin.

The glass transition temperature of the polyester resin is preferably in a temperature range of equal to or higher than 40 degrees centigrade but lower than 70 degrees centigrade, and more preferably in a temperature range of equal to or higher than 45 degrees centigrade but lower than 65 degrees centigrade. If the glass transition temperature is lower than 40 degrees centigrade, then the storage stability of the toner is low when compared with the case where the glass transition temperature is within the ranges above. If the glass transition temperature is higher than 70 degrees centigrade, then the low-temperature fixing property of the toner is decreased when compared with the temperature within the range above.

The color fading agent may be any well-known color fading agent that can be fade (i.e., an image arising therefrom “erased” when incorporated in a three-component system comprising a color generation compound, a color developing agent and a color fading agent, by thermally preventing the coloring reaction of the leuco dye and the color developing agent. For example, a coloring/fading mechanism using the known temperature hysteresis of a color fading agent is superior in swiftly fading a color. The chromogenic mixture of the three-component system can be faded after being heated above a specific color fading temperature Th. Further, the color fading mixture remains in the color fading state even if cooled to below the temperature Th. When the mixture is cooled further, the color reaction caused by the leuco dye and the color developing agent at a temperature below a specific color recovery temperature Tc may occur again to return to a chromogenic state, thus, reversible coloring reaction and color fading reaction may both occur. Specifically, when room temperature is set to be Tr, the color fading agent used herein preferably meets the following relationship: Th>Tr>Tc.

The color fading agent enabling the temperature hysteresis may be alcohols, esters, ketones, ethers and acid amides.

Preferably, the color fading agent is an ester, which is, specifically, a carboxylic ester containing a replaceable aromatic ring, the ester of a carboxylic acid containing an irreplaceable aromatic ring and aliphatic alcohol, a carboxylic ester containing a cyclohexyl group in molecule, the ester of fatty acid and irreplaceable aromatic alcohol or phenol, the ester of fatty acid and branched aliphatic alcohol, the ester of dicarboxylic acid and aromatic alcohol or branched aliphatic alcohol, cinnamate dibenzyl, stearin acid heptyl, didecyl adipate, adipic acid dilauryl, adipic acid dimyristyl, adipic acid dicetyl, adipic acid distearyl, trilaurin, trimyristin, tristearin, dimyristin and distearin. Two or more of the components above may be used together.

Embodiments are described below with reference to accompanying drawings.

### Embodiments

Embodiments and detailed description of the embodiments are given below.

DSC Measurement Method

Measurement is conducted using a Q2000 Thermal Analyser produced by TA Instruments Co., Ltd. The sample developer is heated to 180 degrees centigrade from 0 degrees centigrade at a temperature increase rate of 10 degrees/min, then cooled to 0 degree, and heated again to 180 degrees centigrade from 0 degrees centigrade at a temperature increase rate of 10 degrees/min, and DSC endothermic curves are obtained. The temperature increase rate and the measurement temperature further depend on the color fading temperature of the toner used, however, if the temperature rises sharply, then the endothermic peak that will be described later cannot be observed. Further, if the temperature rises so high that the binder resin is decomposed, the endothermic peak in the second heating cannot be observed either.

In the DSC measurement on common electronic photographic toner, the endothermic peak at the melting point of an additive such as a release agent is observed at a temperature in the vicinity of the glass transition temperature of the binder resin in the first heating. The endothermic peak at the glass transition (base shift) point or temperature of the binder resin or at the melting point of an additive such as a release agent is again observed if a second heating is carried out after a cooling operation conducted once the first heating is finished. The disappearance of the endothermic peak relating to a part of the developer different from the glass transition point part of the binder resin in the second heating step, which is a point of the embodiments described herein, refers to the fading of the coloring agent in the first heating step, and the coloring agent maintains this color faded (erased) state even if being cooled to 0 degree. Further, preferably, the endothermic peak which will disappear, i.e., be missing in the second heating step, is the peak having the highest temperature in the first heating. The elimination of the highest temperature endothermic peak means that color fading is realized at a temperature higher than the fixing temperature of the toner and that a fixed (colored) image can be obtained when the toner is not faded by the fixer.

Preparation of Binder Resin Particle Dispersion

An exemplary dispersion may be obtained by mixing 30 parts by weight of polyester resin (acid value: 10 mgkOH/g, Mw15000, Tg50 degrees), 1 part by weight of sodium dodecylbenzenesulfonate (NEOPELEX G15, produced by Kao Corporation) and 69 parts by weight of ion exchange water and the PH of which is adjusted to 12 by using potassium hydroxide is input to a high-pressure homogenizer NANO 3000 (produced by Beryu Corporation), which is processed at a temperature of 150 degrees and a pressure of 150 MPa to obtain a binder resin particle dispersion. When measured using a SALD7000 particle size distribution analyzer produced by Shimadzu Corporation, the obtained particle diameters of the dispersion presents a sharp particle size distribution presenting a volume mean diameter of 0.23 μm and a standard deviation of 0.15.

Preparation of coloring agent micro capsule dispersion 2 parts by weight of 3-(4-diethylamino-2-hexyloxyphenyl)-3-(1-ethyl-2-methylindole-3-yl)-4-aza phthalide serving as leuco dye, 4 parts by weight of 1,1-Bis(4′-hydroxyphenylhexafluoropropane) and 4 parts by weight of 1,1-Bis(4′-hydroxyphenyl)-n-decane serving as a color developing agent and 50 parts by weight of caprylic acid-4-benzyl oxy-phenyl ethyl serving as a color fading agent are uniformly heated and melted, 30 parts by weight of aromatic polyvalent Isocyanate prepolymer and 40 parts by weight of ethyl acetate serving as a capsulation agent are mixed, the mixture is emulsified and dispersed in 300 parts by weight of 8% polyvinyl alcohol solution, the mixture obtained is continuously stirred about 1 h at 70 degrees. Next, 2.5 parts by weigh of water-soluble aliphatic modified amine serving as a reactant is added to the mixture and stirred continuously for 6h, and leuco capsule particles are obtained.

Further, the capsule particle dispersion is placed in a freezer (−30 degrees) to develop color, then ion exchange water is added to obtain 27 w/t % coloring agent micro capsule dispersion. When measured using SALD7000 produced by SHIMADZU Corporation, the volume average particle diameter of the obtained dispersion is 3.3 μm.

Exemplary preparation of coloring agent dispersion 2 parts by weight of 3-(4-diethylamino-2-hexyloxyphenyl)-3-(1-ethyl-2-methylindole-3-yl)-4-aza phthalide serving as leuco dye, 4 parts by weigh of 1,1-Bis(4′-hydroxyphenyl) (hexafluoropropane) and 4 parts by weight of 1,1-Bis(4′-hydroxyphenyl)-n-decane serving as a color developing agent and 50 parts by weight of caprylic acid-4-benzyl oxy-phenyl ethyl serving as a color fading agent are heated and melted, the obtained solution is emulsified and dispersed in 8% polyvinyl alcohol to obtain leuco coloring agent dispersion. The coloring agent dispersion is placed in a freezer (−30 degrees) to develop color, then ion exchange water is added to obtain 27 w/t % coloring agent dispersion. When measured using the SALD7000 particle size dispersion analyzer produced by Shimadzu Corporation, the volume average particle diameter of the obtained dispersion is 1.1 μm.

Exemplary preparation of release agent particle dispersion

The dispersion obtained by mixing 20 parts by weight of carnauba wax, 1 part by weight of alkenylsulfonyl dipotassium (Ramuteru ASK produced by Kao Corporation) and 79 parts by weight of ion exchange water is input to a rotor/stator type homogenizer CLEARMIX 2.2S (produced by M Technique Corporation), the mixture is stirred at a speed of 1000 rpm while being heated to 100 degrees centigrade to obtain a release agent particle dispersion. When measured using SALD7000 produced by Shimadzu Corporation, the volume average particle diameter of the obtained dispersion is 0.5 μm.

### Embodiment 1

The binder resin particle dispersion, the coloring agent micro capsule dispersion and the release agent particle dispersion are measured so that the concentration or composition by weight of the coloring agent is 15%, the concentration of the release agent is 10% and the concentration of the binder resin is 75%, then coagulated particles having a diameter of 8 um are prepared by taking ammonium sulfate as an coagulating agent, the prepared particles are heated to 60 degrees centigrade and melted and then cooled, then, a coloring particle dispersion is obtained. The solid and the liquid contained in the obtained coloring particle dispersion are separated by using a filter press and then washed with pure water, next, the coloring particles are dried in vacuum, 2 parts by weight of hydrophobic silica and 0.5 part by weight of oxidized titanium serving as an additive are attached to the surface of toner particles, then, a coloring toner having a particle diameter of 8 μm is obtained.

The obtained toner is mixed with a ferrite carrier coated with silicone resin, and an image output is carried out by a Multi Function Peripheral (MFP) (e-studio 4520) produced by Toshiba Tec Corporation). The temperature of a fixer is set to be 80 degrees, and the paper feeding speed is adjusted to be 30 mm/sec, thereby obtaining a coloring image having an image density of 0.5.

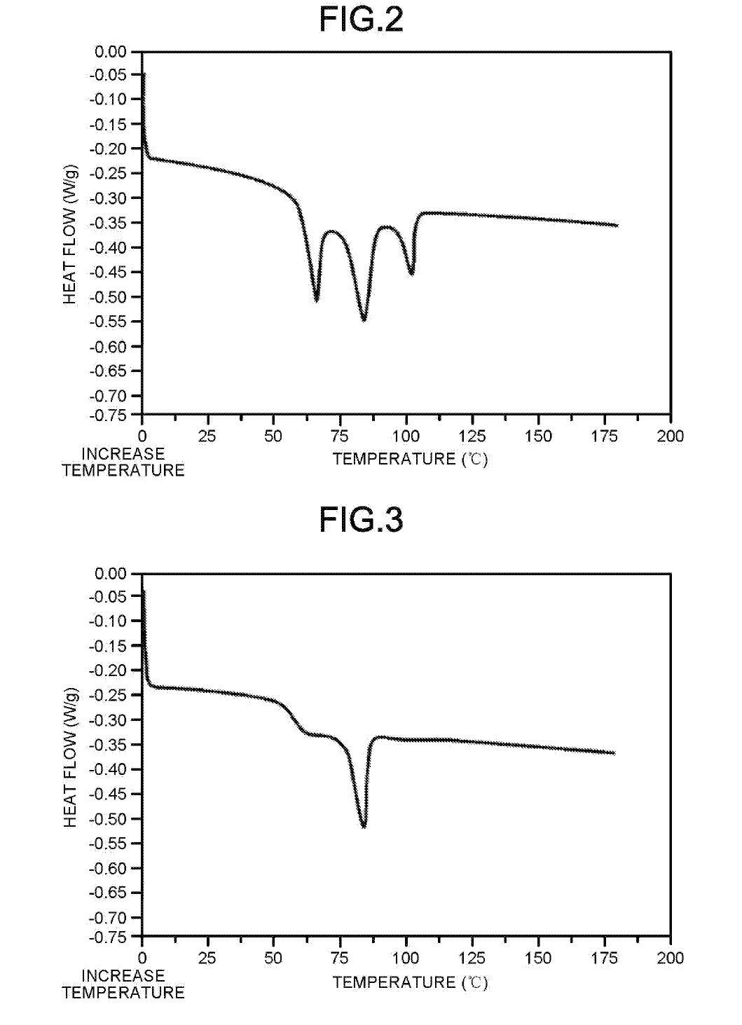

FIG. 2 is a graph illustrating a DSC curve resulting from a first DSC measurement according to embodiment 1.

FIG. 3 is a graph illustrating a DSC curve resulting from a second DSC measurement according to embodiment 1.

In the DSC measurement on the toner obtained, endothermic peak is observed at a temperature in the vicinity of 65 degrees, 80 degrees centigrade and 100 degrees centigrade in the first heating, and in the second heating, the base shift caused by the glass transition of the binder resin is observed at about 60 degrees centigrade, endothermic peak is observed at about 80 degrees centigrade and is not present (i.e., it disappeared) at about 100 degrees centigrade.

The obtained coloring image is conveyed at a set fixer temperature of 150 degrees centigrade and at a paper feeding speed of 200 mm/sec to make the image density of the image be 0.1, thus confirming that the coloring image is faded instantly. Images on a standard A4 paper sheet (210 mm×297 mm) may thus be erased in less than 1.5 seconds, and each portion of the image is instantaneously faded or erased as it encounters the fading or erasing temperature.

The color faded image obtained is stored in a freezer at a temperature of −20 degrees centigrade to confirm that the image density of the obtained color fading image returns to 0.5, which the image density of the image is no longer faded, i.e. it is visible to the human eye

### Embodiment 2

A coloring toner having a diameter of 8 μm is obtained in the way used in embodiment 1 except that the coloring agent micro capsule dispersion changes to a coloring agent dispersion.

A coloring toner is obtained after the toner obtained is stored in a freezer at a temperature of −30 degrees centigrade for one week.

The obtained toner is mixed with a ferrite carrier coated with silicone resin, and an image output (paper is imaged with the toner) is carried out in an MFP (e-studio 4520) produced by Toshiba Tec Corporation). The temperature of the fixer is set to be 80 degrees centigrade, and the paper feeding speed is adjusted to be 30 mm/sec, thereby obtaining a coloring image having an image density of 0.4.

In the DSC measurement on the toner obtained, as with the embodiment 1, endothermic peaks are observed at a temperature in the vicinity of 65 degrees centigrade, 80 degrees centigrade and 100 degrees centigrade in the first heating step, and in the second heating step, the base shift caused by the glass transition of the binder resin is observed at a temperature in the vicinity of 60 degrees centigrade, and endothermic peak is observed at about 80 degrees centigrade and is not present, i.e., it disappears, at about 100 degrees centigrade. Thus, the image of the colored toner may be erased by heating the image to at least about 100 degrees, such as by passing the image over a heated roller of an MFP set at an erasing or fading temperature.

The obtained coloring image is conveyed at a set fixer temperature of 150 degrees centigrade and a paper feeding speed of 200 mm/sec to make the image density of the image be 0.1 as measured by an optical device such as a Macbeth densitometer, where the image density is log (1/T), where T is a ratio of reflectance, which confirms that the coloring image is faded instantly.

As stated above, an electronic photographic toner which can be faded instantly can be provided with the structure above.

### Comparative Embodiment 1

84 parts by weight of polyester resin (glass transition temperature: 45 degrees centigrade, softening point: 100 degrees centigrade) serving as a binder resin, 5 parts by weight of Rice wax serving as a release agent, 1 part by weight of TN-105 (produced by Hodogaya Chemical Co., Ltd) serving as a charge controlling agent, 0.3 part by weight of 3-(4-diethylamino-2-hexyloxyphenyl)-3-(1-ethyl-2-methylindole-3-yl)-4-aza phthalide serving as a leuco dye, 0.6 part by weight of 1,1-Bis(4′-hydroxyphenyl)hexafluoropropane and 0.6 part by weight of 1,1-Bis(4′-hydroxyphenyl)-n-decane serving as a color developing agent and 8.5 parts by weight of caprylic acid-4-benzyl oxy-phenyl ethyl serving as a color fading agent are uniformly mixed by using a dry mixer, the mixture is fused and kneaded using the PCM-45 of a two-shaft kneading machine (produced by Ikegai Corporation) at 100 degrees, then a substantially leuco kneaded material is obtained. The kneaded material obtained is milled by using a pin mill to be particles having a diameter of 2 mm (mesh pass).

Next, the particles are crushed and graded using a jet mill, and 2 parts by weight of hydrophobic silica and 0.5 parts by weight of oxidized titanium serving as additive are attached to surfaces of the toner particles, then a leuco toner is obtained. When measured by the multisizer 3 produced by Coulter Corporation, the volume average particle diameter Dv of 50% is 8.5 μm.

A coloring toner is obtained after the toner obtained is stored in a freezer at a temperature of −30 degrees centigrade for one week.

The obtained toner is mixed with a ferrite carrier coated with silicone resin, and an image output is carried out by a MFP (e-studio 4520C) produced by Toshiba Tec Corporation. The temperature of a fixer is set to be 80 degrees, and the paper feeding speed is adjusted to be 30 mm/sec, then, a coloring image having an image density of 0.5 is obtained.

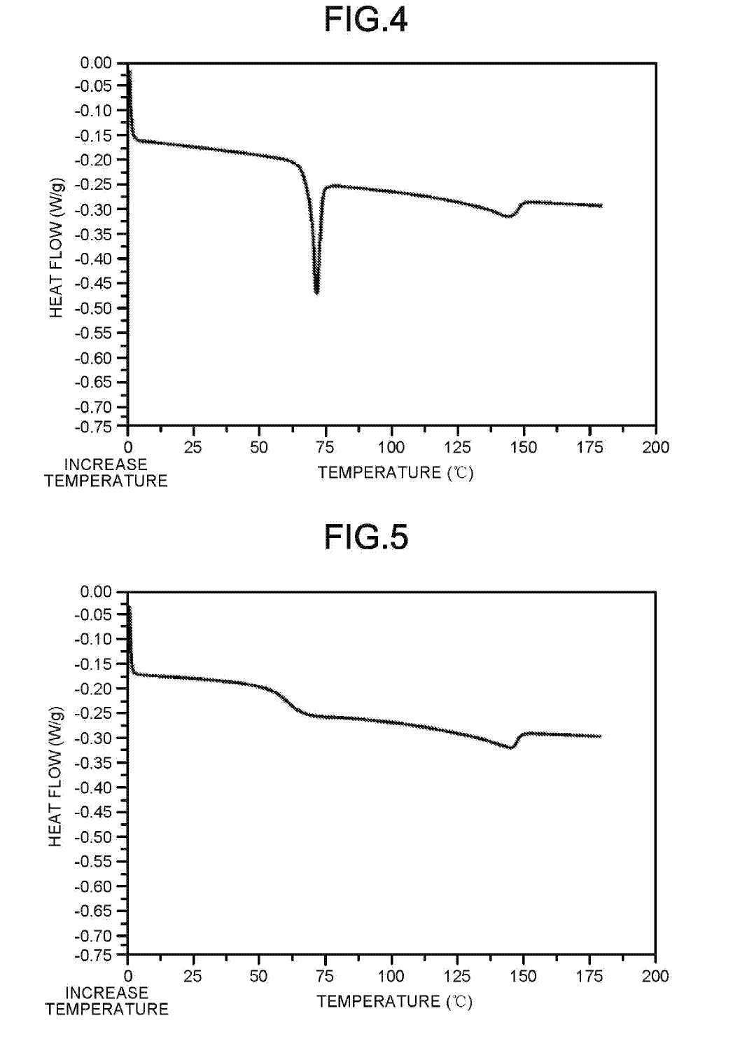

FIG. 4 is a graph illustrating a DSC curve resulting from a first DSC measurement according to comparative embodiment 1.

FIG. 5 is a graph illustrating a DSC curve resulting from a second DSC measurement according to comparative embodiment 1.

In the DSC measurement on the toner obtained, endothermic peak is observed at a temperature in the vicinity of 75 degrees and 150 degrees in the first heating, and in the second heating, the base shift caused by the glass transition of the binder resin is observed at a temperature in the vicinity of 65 degrees, endothermic peak is observed at a temperature in the vicinity of 150 degrees, and there is no endothermic peak disappearing in addition to glass transition peak. In other words, but for the change in the traces at the glass transition temperature of the binder resin, the curves are substantially the same.

The obtained coloring image is conveyed at a set fixer temperature of 150 degrees centigrade and at a paper feeding speed of 200 mm/sec, the image density of the image is kept at 0.5, which disenables instant fading. Further, instant fading cannot be realized even if the fixer temperature is set to be 200 degrees. In addition, after the faded image is maintained at a temperature of about 180 degrees centigrade for about 1 h, the image density of the image becomes 0.1, thus realizing fading. Thus instant fading of the image is not accomplished.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention. Also, the term “color” as used herein, is meant to include colors, including those on the RGB scale and black and white, such that an image, having a color, such as white on a dark background, may be faded or erased by heat such that the white is no longer visible to the human eye.

What is claimed is:

1. A color-fadable medium having a binder resin, wherein
when the color-fadable medium is heated from a temperature range of 0° C. to 20° C. to a temperature range of 150° C. to 180° C. at a temperature increase rate range of 5 degrees/min to 10 degrees/min a first time, a first differential scanning calorimetry curve based on the first heating step has an additional endothermic peak than a differential scanning calorimetry curve of the same medium heated a second time from the same starting temperature range to the same ending temperature range at the same temperature increase rate range as the first heating step, and that the additional endothermic peak is different from the endothermic peak caused by a glass transition point of a binder resin in the color fadable medium.

2. The medium of claim 1, wherein
the endothermic peak which is not present in the second differential scanning calorimetry curve is the highest temperature peak in the first differential scanning calorimetry curve.

3. The medium of claim 1, wherein the color in the medium can be faded by being heating by a heated roller in an MFP.

4. The medium of claim 3, wherein the color in the faded medium may be returned to visibility by maintaining the medium at −20° C. for an hour.

5. The medium of claim 1, wherein the medium is a developer.

6. The medium of claim 5, wherein the developer includes the binder resin, a color generation compound and a color developing agent.

7. The medium of claim 1, wherein the medium is a toner.

8. An erasable image system, comprising a colored media in which the color of the media may be faded to a state in which it is not readily discernible to the human eye, and wherein, upon heating the media twice from approximately 0 to 20° C. to a temperature of 150 to 180° C., at a temperature ramp rate of less than 10° C. per minute and generating a first differential scanning calorimetry curve during the first heating and a second differential scanning calorimetry curve during the second heating, the first curve and the second curve have different endothermic peaks.

9. The system of claim 8, wherein the second differential scanning calorimetry curve has fewer peaks than the first differential scanning calorimetry curve.

10. The system of claim 9, wherein the second differential scanning calorimetry curve has one fewer peak than the first differential scanning calorimetry curve.

11. The system of claim 10, wherein the one less peak in the second differential scanning calorimetry curve is the peak in the first differential scanning calorimetry curve occurring at the highest temperature.

12. The system of claim 9, wherein the one less peak in the second differential scanning calorimetry curve is not at a glass transition temperature of a binding resin of the media.

13. The system of claim 8, wherein the media is a developer.

14. The system of claim 8, wherein the media is a toner.

15. The system of claim 8, further including an apparatus capable of heating the media to set a color image of the media onto a sheet, and also capable of heating the media to a temperature to cause fading of the color image of the media on the sheet.

16. A test method for evaluating the color fading properties of a color-fadable developer, comprising the steps of:
twice performing differential scanning calorimetry on the developer by heating the color-fadable developer containing a binder resin, a color generation compound and a color developing agent from a temperature range of 0° C. to 20° C. to a temperature range of 150° C. to 180° C. at a temperature increase rate range of 5 degrees/min to 10 degrees/min;
determining the relationship between heat flow and temperature of the developer during the heating thereof; and
determining, using the results of the differential scanning calorimetry, that the developer has an endothermic peak in the first heating step that is not present in the second heating step.

17. The test method of claim 16, comprising:
determining if the endothermic peak that was present in the first heating step but was not present in the second heating step is different from the endothermic peak caused by the glass transition point of the binder resin.

18. The test method of claim 17, wherein
the endothermic peak missing during the second heating step is the highest temperature peak occurring in the first heating step.

19. The test method of claim 16, further including the steps of:
plotting the data resulting from the differential scanning colorimetry evaluation of the developer in the first and the second heating steps; and
comparing the plotted curves to determine whether a thermal peak occurring in the plot of the first heating step is not present in the plot of the second heating step, and that the thermal peak that is not present in the plot of the second heating step is different that the thermal peak appearing in the plot of the first heating step at the glass transition point of a developer component.

20. The test method of claim 19, wherein the glass transition point of a developer component is the glass transition point of the binder resin.
